(19) United States
(12) Patent Application Publication
(10) Pub. No.: US 2021/0282362 A1
(43) Pub. Date: Sep. 16, 2021

(54) DUST ABATEMENT IN PARTICULATE CLAY

(71) Applicant: Rohm and Haas Company, Collegeville, PA (US)

(72) Inventors: Andrea C. Keenan, Pottstown, PA (US); Melissa S. Leach, Birdsboro, PA (US); Theodore Tysak, Ambler, PA (US)

(73) Assignees: Rohm and Haas Company, Collegeville, PA (US); Rohm and Haas Company, Collegeville, PA (US)

(21) Appl. No.: 16/336,656

(22) PCT Filed: Oct. 3, 2017
(86) PCT No.: PCT/US2017/054850

§ 371 Date: Mar. 26, 2019

Related U.S. Application Data
(60) Provisional application No. 62/404,791, filed on Oct. 6, 2016.

(51) Int. Cl. A01K 1/015

(52) U.S. Cl. CPC A01K 1/0154

(57) ABSTRACT

A method for reducing dust in particulate clay. The method comprises contacting clay particles with a polymer comprising at least 50 wt % polymerized units of acrylic acid and having M_{w} from 1,000 to 100,000.

### BACKGROUND

This invention relates generally to a method for reducing dust in particulate clays used as absorbents, e.g., cat litter used in cat litter boxes.

Although bentonite clays are desirable carrier materials, they have the disadvantage of generating large amounts of dust upon handling because of their small particle size. This dust generation problem is known and various solutions have been previously proposed. For example, introduction of a clumping absorbent material and a tackifying agent to clay is proposed in US2016/0044891A. It would be desirable to have additional solutions available for this problem.

The problem addressed by this invention is to find an improved method for reducing dust in particulate clays, especially in cat litter.

### STATEMENT OF INVENTION

The present invention is directed to a method for reducing dust in particulate clay; said method comprising contacting clay particles with a polymer comprising at least 50 wt % polymerized units of acrylic acid and having M_{w} from 1,000 to 100,000.

### DETAILED DESCRIPTION

All percentages are weight percentages (wt %), and all temperatures are in ° C., unless otherwise indicated. All operations were performed at room temperature (20-25° C.), unless otherwise specified. Weight percentages of polymer are based on dry polymer (“polymer solids”). Weight percentages of polymerized monomer units in a polymer are based on the weight of the dry polymer. (Meth)acrylic or (meth)acrylate means acrylic or methacrylic, or acrylate and methacrylate, respectively. Weight average molecular weights, M_{w}, are measured by gel permeation chromatography (GPC) using polyacrylic acid standards, as is known in the art. The techniques of GPC are discussed in detail in Modern Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. The molecular weights reported herein are in units of daltons.

Cat litter is absorbent material, often in a granular form that is used to line a receptacle in which a domestic cat can urinate and defecate indoors. There are many different types of cat litters available, but essentially most of them fall into three distinct categories: clay-based, silica-based, and biodegradable. Clay-based litters are largely absorbent clay material, often with small amounts of limestone, crystallized silica, sodium tetraborate, or a combination thereof. The smectite family of clays includes the various mineral species montmorillonite (in particular a bentonite-montmorillonite clay), nontronite, hectorite and saponite, all of which can be present in the clay mineral in varying amounts. Typically, clay-based litters comprise from 55-98 wt % clay; preferably at least 60 wt %, preferably at least 65 wt %, preferably at least 70 wt %; preferably no more than 95 wt %, preferably no more than 90 wt %. Preferably the clay is primarily bentonite, preferably at least 50 wt % of the clay is bentonite, preferably at least 75 wt %, preferably at least 90 w %, preferably at least 95 wt %. Preferably, the litter further comprises from 5 to 30 wt % minerals comprising calcium and/or magnesium; preferably at least 10 wt %, preferably at least 15 wt %; preferably no more than 25 wt %, preferably no more than 20 wt %. Preferably, the litter further comprises from 0.5 to 10 wt % silica, preferably 0.5 to 8 wt %, preferably 0.5 to 6 wt %.

Silica-based litters are largely crystallized silica. Biodegradable litters are made from various plant resources, including pine wood pellets, wood shavings, wood chips, recycled newspaper, clumping sawdust, Brazilian cassava, corn, wheat, walnuts, barley, okara and dried orange peel. Preferably, the particulate clay is substantially free of a clumping agent, e.g., cellulose, cellulose derivatives (including carboxymethylcellulose and alkyl and/or hydroxyalkyl cellulose ethers), guar, xanthan gum, starch or polyethylene oxide. The term substantially free means containing no more than 2 wt %, preferably no more than 1 wt %, preferably no more than 0.5 wt %, preferably no more than 0.2 wt %, preferably no more than 0.1 wt %, preferably 0 wt %, based on total weight of clay.

Preferably, particulate clay has an average particle diameter in the range from 4 mesh sieve size (4760 microns) to 60 mesh sieve size (250 microns), preferably from 18 mesh sieve size (1000 microns) to 60 mesh sieve size (250 microns). Preferably, the polymer is contacted with the clay particles by spraying a solution of the polymer or polymer formulation onto the clay particles during mixing and then drying the coated clay particles, e.g., through a belt or conveyor drying line.

Polymers used in this invention typically comprise a film-forming or binder polymer, generally in the form of an aqueous dispersion or emulsion. Polymer binders suitable for use in the invention typically have glass transition temperatures, Tg, from −41 to 130° C.; preferably at least 10° C., preferably at least 30° C., preferably at least 40° C.; preferably no more than 120° C., preferably no more than 110° C. The “glass transition temperature,” or “T_{g},” as used herein, means the temperature at or above which a glassy polymer will undergo segmental motion of the polymer chain. Glass transition temperatures of a polymer can be estimated by the Fox Equation (Bulletin of American Physics Society, 1 (3), p 123, 1956), as follows:

1/T_{g}=w1/T_{g,1}+w2/T_{g,2}

For a copolymer comprising two types of monomers, w1 and w2 refer to the weight fraction of the two monomers, and T_{g,1} and T_{g,2} refer to the glass transition temperatures of the two corresponding homopolymers made from the monomers. For polymers containing three or more monomers, additional terms are added (wn/Tg,n). The T_{g} of a polymer can also be measured by various techniques including, for example, differential scanning calorimetry (DSC).

Polymer binders are preferably water insoluble emulsion polymers derived from one or more ethylenically unsaturated monomers, typically in the form of an aqueous dispersion. In addition to acrylic acid, suitable ethylenically unsaturated monomers include other ethylenically unsaturated carboxylic or sulfonic acids, such as methacrylic acid and 2-acrylamido-2-methylpropanesulfonic acid; derivatives of carboxylic acid monomers, such as (C₁-C₂₀)alkyl (meth)acrylate esters, carboxylic acid anhydrides and (meth)acrylamide; vinylaromatic monomers, vinyl alkyl monomers, and combinations thereof. Preferred monomers include methacrylic acid; vinylaromatic monomers, preferably styrene; maleic anhydride; 2-acrylamido-2-methylpropanesulfonic acid; diisobutylene.

Definition of Monomers used:
AA Acrylic Acid or Acrylate
MAA Methacrylic Acid or Methacrylate
AMPS 2-acrylamido-2-methylpropanesulfonic acid
STY styrene
MAnh Maleic anhydride
DIIB Diisobutylene
EA Ethylacrylate
Malac Maleic acid
TEA Triethanol amine
SHP Sodium Hypophosphite
BA Butyl Acrylate
AMPS Acrylamide
MMA MethylMethacrylate
HEMA HydroxyethylMethacrylate

Acrylic monomers include (meth)acrylic acid, (meth)acrylate esters having C₁-C₂₀ alkyl or hydroxyalkyl groups, maleic acid, maleic anhydride, acrylamide, methacrylamide, itaconic acid and crotonic acid. Preferably, the polymer has at least 60 wt % polymerized units of acrylic monomers, preferably at least 65 wt %, preferably at least 70 wt %, preferably at least 75 wt %, preferably at least 80 wt %, preferably at least 85 wt %, preferably at least 90 wt %, preferably at least 98 wt %. Preferably, the polymer comprises from 60 to 100 wt % polymerized units of monomers selected from (meth)acrylic acid, maleic anhydride and maleic acid; preferably at least 60 wt %, preferably at least 70 wt %, preferably at least 80 wt %, preferably at least 90 wt %. Preferably, the polymer comprises from 60 to 100 wt % polymerized units of monomers selected from acrylic acid, maleic anhydride and maleic acid; preferably at least 60 wt %, preferably at least 70 wt %, preferably at least 80 wt %, preferably at least 90 wt %. Preferably, the polymer comprises from 60 to 100 wt % polymerized units of acrylic acid; preferably at least 65 wt %, preferably at least 70 wt %, preferably at least 75 wt %.

Preferably, the polymer has no more than 0.5 wt % polymerized units of a cross-linker (i.e., a multiethylenically unsaturated compound), preferably no more than 0.2 wt %, preferably no more than 0.05 wt %, preferably no more than 0.025 wt %, preferably no more than 0.01 wt %. Preferably, the average particle size of the emulsion polymer particles is from 100 nm to 1,000 nm, preferably at least 150 nm, preferably at least 200 nm; preferably no greater than 900 nm, preferably no greater than 800 nm, preferably no greater than 700 nm.

Preferably, the polymer has M_{w} at least 2,000, preferably at least 2,500, preferably at least 3,000, preferably at least 3,500; preferably no greater than 90,000, preferably no greater than 80,000, preferably no greater than 70,000, preferably no greater than 60,000, preferably no greater than 50,000, preferably no greater than 40,000, preferably no greater than 30,000, preferably no greater than 20,000.

Preferably, the polymer is added to a dry composition comprising a particulate clay in an amount from 0.1 to 2 wt % of the clay; preferably at least 0.15 wt %, preferably at least 0.2 wt %, preferably at least 0.25 wt %; preferably no more than 1.5 wt %, preferably no more than 1 wt %, preferably no more than 0.5 wt %.

### Examples

### Test Method Description:

To validate our findings, we used turbidity readings and settled dust particles. The approach with the turbidity reading is to analyze the particle suppression provided by the compositions of the invention to determine the suspension of particles in water extractions from coated and uncoated animal litter by measuring the turbidity of the water extractions. Turbidity is measured by an instrument called a nephelometer. The units of turbidity from a nephelometer are Nephelometric Turbidity Units (NTU). High NTU values indicate higher turbidity and lower NTU values indicate lower turbidity. Turbidity in the water extractions of the coated and uncoated animal litter is due to particles suspended in the water. Low NTU values of the coated animal litter indicate that fewer particles are extracted from the coated animal litter demonstrating particle dust suppression. We would spray the dust suppressant agent directly onto the cat litter using a spraying apparatus. Thus spreading the dust suppressant agent as evenly as possible over the animal litter to make as uniform as possible. Then immediately mixed by pouring the animal litter in to an appropriate sized jar and mixed by shaking and rolling the jar for 2 minutes. Then the animal litter was allowed to dry at ambient temperature.

After drying, 3 grams of the animal litter is placed into a 1 ounce vial. Then 25 milliliters of deionized water is placed into the 1 ounce vial on top of the 3 grams of the animal litter Immediately invert the vial 15 times quickly to mix the deionized water and animal litter Immediately after the 15^{th} inversion, remove the top 11 milliliters and place into another 1 ounce vial. Immediately read the 1 ounce vial in turbidimeter. We used AF Scientific Micro 100 Turbidimeter to take our turbidity reading. We took a turbidity reading at time 0 (initial reading), 1 minute, 2 minute, 5 minute, 1 hour and 24 hours. The lower turbidity reading indicates that there are less particles floating in the deionized water and taking the top 11 milliliters allows us to take only the smallest particles (typically causes the dusting phenomena).

### Bench Top Screening Method Using Litter:

1. Weigh 10 g litter in 4 oz jar.
2. Spray with test solution. Shake/stir as needed and let dry at ambient conditions for 1 hr.
3. Weigh out 3 g into vial and add 25 mL DI
4. Cap and shake 15 times and immediately pipette 11 g from the top and place in to another vial.
5. Read NTU vs time.
The quantity of test solution that is sprayed is controlled to reach 0.5 wt % on the cat litter. The cat litter used for testing contained 70-90% bentonite, 10-25% limestone, <6% silica and 0.1-1% borax.

If the NTU is greater than 1100 NTU, then a system out of range (OR) is reported because an accurate reading cannot be obtained. Of particular interest are data generated in the first 5 minutes to 1 hour of the testing, which correlate best with particle dust suppression.

### Sample Description Table A:

The following Sample Description Tables A-F represent all the sample formulations tested for their ability to suppress dust generated from animal litter. Table A describes compositions, percent solids and molecular weight of samples KL-27A through KL-46B.

| | | % | | |
|---|---|---|---|---|
| | M_{w} | solids | pH | pAA, % |
| KL-27A | | 10 | 3.5-4.5 | 50.9 (TEA-H Cation, SHP-H20) |
| KL-27B | | 50 | 3.5-4.5 | |
| KL-28A | | 10 | 2.1-2.9 | 33.4 (Glycerol, SHP) |
| KL-28B | | 53 | 2.1-2.9 | |
| KL-29A | | 10 | 2.1-3.0 | 37.3 |
| KL-29B | | 47 | 2.1-3.0 | (TEA-H)₂SO4, SHP-H₂O |
| KL-30A | 2000 | 10 | 3.2-4 | 100AA |
| KL-30B | | 48 | | |
| KL-32A | 30000 | 10 | 10 | 100MAA |
| KL-32B | | 30 | | |
| KL-31A | 2000 | 10 | 2.1-2.5 | 100AA |
| KL-31B | | 40 | | |
| KL-33A | 4500 | 10 | 7 | 100 AA |
| KL-33B | | 45 | | |
| KL-34A | 4500 | 10 | 3 | 100 AA |
| KL-34B | | 48 | | |
| KL-35A | 70000 | 10 | 7 | 70 AA/30MAnh |
| KL-35B | | 40 | | |
| KL-36A | 10000 | 10 | 10 | 50MAnh/50 DIIB |
| KL-36B | | 25 | | |
| KL-37A | 2000 | 10 | 7.2 | 90AA/10 Maleic |
| KL-37B | | 50 | | |
| KL-38A | 4500 | 10 | 4.2 | 77 AA/23 AMPS |
| KL-38B | | 43 | | |
| KL-39A | 3200 | 10 | 3 | 90 AA/10MAnh |
| KL-39B | | 50 | | |
| KL-40A | 4000 | 10 | 2 | 30 AA/70 C12-15, ~12 EO |
| KL-40B | | 50 | | |
| KL-41A | 3500 | 10 | 4.4 | 70AA/30MAA |
| KL-41B | | 50 | | |
| KL-42A | 10800 | 37 | 4.5 | 60 AA/40 AMPS |
| KL-42B | | | | |
| KL-43A | 70000 | 10 | 8 | 70 AA/30MAnh |
| KL-43B | | 40 | | |
| KL-44A | 10000 | 10 | 7 | 100 AA |
| KL-44B | | 40 | | |
| KL-45A | 11000 | 10 | 7 | 100AA |
| KL-45B | | 34.41 | | |
| KL-46A | 40000 | 35 | 7 | 80/20 AA/Malac |
| KL-46B | | 35 | | |

### Sample Description Table B:

The following Sample Description represent all the sample formulations tested for their ability to suppress dust generated from animal litter. Table B describes compositions, percent solids and molecular weight of samples PS-15, PS-26, PS-27, PS-33, PS-36 and PS-57.

| | PS-15 | PS-26 | PS-27 | PS-33 | PS-36 | PS-57 |
|---|---|---|---|---|---|---|
| Alcohols, C₆-C₁₂, ethoxylated, propoxylated | 15 | | | 15 | | 15 |
| Alcohols, C₁₀-₁₆, ethoxylated, propoxylated | | | | | | |
| Nonionic surfactant 2-ethylhexanol EO PO | | 15 | 15 | | 15 | |
| Anionic surfactant Alkyldiphenyloxide | | | | | | |
| disulfonate | | | | | | |
| Polymer 70 BA/28 Sty/2 AM | 7.5 | | | | 7.5 | |
| Polymer 28 BA/62 MMA/10 MAA with | | 11.35 | | | | |
| polyvalent metal crosslinker Zn; Tg = 46° C. | | | | | | |
| Polymer 30 BA/15 MMA/40 STY/5 | | | | 11.05 | | |
| HEMA/5 AA/ 5 MAA with polyvalent metal | | | | | | |
| crosslinker, Zn; Tg = 38° C. | | | | | | |
| Polymer 98 BA/2 MAA with polyvalent | | | 8.4 | | | 8.4 |
| metal crosslinker, Zn; Tg = −41° C. | | | | | | |
| * | 2.17 | 2.92 | 2.92 | 2.5 | 2.17 | 2.5 |
| ** | 75.33 | 70.73 | 73.68 | 71.45 | 75.33 | 74.1 |
| | 100 | 100 | 100 | 100 | 100 | 100 |

* In all tables this line is the total amount of 1% solvent (2,2,4-trimethyl-1,3-pentanediol mono(2-methylpropanoate)); 1% silicone based defoamer; and sodium hydroxide (10% solution) to adjust viscosity.
** In all tables this line is the % added water.

### Sample Description Table C:

The following Sample Description represent all the sample formulations tested for their ability to suppress dust generated from animal litter. Table C describes compositions, percent solids and molecular weight of samples PS-59, PS-65, PS-70, PS-138, A-1 and A-2.

| | PS-59 | PS-65 | PS-70 | PS-138 | A-1 | A-2 |
|---|---|---|---|---|---|---|
| Alcohols, C₆-C₁₂, ethoxylated, propoxylated | | | | 15 | | |
| Alcohols, C₁₀-₁₆, ethoxylated, propoxylated | | | | | | |
| Nonionic surfactant 2-ethylhexanol EO PO | | 12.5 | | | | |
| Nonionic surfactant alkyl polyglucoside | 29.5 | | | | | |
| Anionic surfactant Alkyldiphenyloxide | | | 15 | | | |
| disulfonate | | | | | | |
| Polymer 70 BA/28 Sty/2 AM | 7.5 | | 7.5 | | | |
| Anionic polymer Ethylene/octene copolymer | | | | 8.4 | | |
| and ethylene/sodium acrylate copolymer | | | | | | |
| Polymer BA/EA/MMA/HEMA/MAA, mw | | | | | | 10 |
| 70-120K | | | | | | |
| Polymer BA/MMA/HEMA/MAA, mw | | | | | 10 | |
| 70-90K | | | | | | |
| Diethylene Glycol Monohexyl Ether solvent | | 2.6 | | | | |
| | 2.17 | 2.92 | 2.92 | 2.5 | 2.17 | 2.5 |
| | 75.33 | 70.73 | 73.68 | 71.45 | 75.33 | 74.1 |
| | 100 | 100 | 100 | 100 | 100 | 100 |

### Sample Description Table D:

The following Sample Description represent all the sample formulations tested for their ability to suppress dust generated from animal litter. Table D describes compositions, percent solids and molecular weight of samples A-3, KL-3, KL-4, KL-5, KL-6 and KL-7.

| | A-3 | KL-3 | KL-4 | KL-5 | KL-6 | KL-7 |
|---|---|---|---|---|---|---|
| Polymer 70 BA/28 Sty/2 AM | | | | 8.93 | | |
| Polymer 28 BA/62 MMA/10 MAA with | | 13.16 | | | | |
| polyvalent metal crosslinker, Zn; Tg = 46° C. | | | | | | |
| Anionic polymer Ethylene/octene copolymer | | | 10 | | | |
| and ethylene/sodium acrylate copolymer | | | | | | |
| Polymer BA/EA/MMA/HEMA/MAA, mw | 10 | | | | | |
| 50-70K | | | | | | |
| Cationic polymer Ethylene/octene copolymer | | | | | 20 | |
| and ethylene/sodium acrylate copolymer | | | | | | |
| Anionic polymer Ethylene/octene copolymer | | | | | | 20 |
| and ethylene/sodium acrylate copolymer | | | | | | |
| | 90 | 86.84 | 90 | 91.07 | 80 | 80 |
| | 100 | 100 | 100 | 100 | 100 | 100 |

### Sample Description Table E:

The following Sample Description represent all the sample formulations tested for their ability to suppress dust generated from animal litter. Table E describes compositions, percent solids and molecular weight of samples KL-12, KL-13, KL-14, KL-15, KL-16, and KL-17.

| | KL-12 | KL-13 | KL-14 | KL-15 | KL-16 | KL-17 |
|---|---|---|---|---|---|---|
| Alcohols, C₆-C₁₂, ethoxylated, propoxylated | | | 15 | | | |
| Alcohols, C₁₀-₁₆, ethoxylated, propoxylated | | | | | | |
| Polymer 98 BA/2 MAA with polyvalent | | 10 | | | | |
| metal crosslinker, Zn; Tg = −41° C. | | | | | | |
| Anionic polymer Ethylene/octene copolymer | | | 8.4 | | | |
| and ethylene/sodium acrylate copolymer | | | | | | |
| Polyacrylic acid polyethylene glycol | 8.42 | | | | | |
| Polymer hydroxypropyl methylcellulose | | | | 0.5 | | |
| Polymer hydroxyethyl cellulose | | | | | 1 | |
| Polyethylene glycol polymer | | | | | | 1 |
| | 91.58 | 90 | 76.6 | 99.5 | 99 | 99 |
| | 100 | 100 | 100 | 100 | 100 | 100 |

### Sample Description Table F

The following Sample Description represent all the sample formulations tested for their ability to suppress dust generated from animal litter. Table F describes compositions, percent solids and molecular weight of samples KL-18, KL-19, KL-20, KL-21, KL-22, KL-24, and KL-25.

| | KL-18 | KL-19 | KL-20 | KL-21 | KL-22 | KL-24 | KL-25 |
|---|---|---|---|---|---|---|---|
| Modified polyethylene glycol | 1 | | | | | | |
| Polyquaternium-10 Quaternized | | 0.5 | | | | | |
| hydroxyethyl cellulose polymer | | | | | | | |
| Polyquaternium-67 Quaternized | | | 0.5 | | | | |
| hydroxyethyl cellulose polymer | | | | | | | |
| Polyethylene oxide polymer | | | | 1 | | | |
| Diethylene Glycol Monohexyl Ether | | | | | | | |
| solvent | | | | | | | |
| Solvent 2,2,4-trimethyl-1,3-pentanediol | | | | | 1 | | |
| mono(2-methylpropanoate) | | | | | | | |
| Silicone based defoamer | | | | | | 1 | |
| | 99 | 99.5 | 99.5 | 99 | 99 | 99 | 90 |
| | 100 | 100 | 100 | 100 | 100 | 100 | 100 |

Example tables 1-10 below represent evaluations of dust suppression of animal litter using a bench top screening method for clarity. Clarity measurements can be correlated to dust suppression. Turbidity is measured by an instrument called a Nephelometer. The units of turbidity from a Nephelometer are Nephelometric Turbidity Units (NTU). High NTU values indicate higher turbidity and lower NTU values indicate lower turbidity. Turbidity in the water extractions of the coated and uncoated animal litter is due to particles suspended in the water. Low NTU values of the coated animal litter indicate that fewer particles are extracted from the coated animal litter demonstrating particle dust suppression.

Table 1 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series that PS-26 is best in this data set for dust suppression, then PS-27, PS-36 and PS-32. PS-59 performed worse than the control in this data set.

TABLE 1

| Time | | control | PS-15 | PS-26 | PS-27 | PS-32 | PS-36 | PS-59 | PS-138 |
|---|---|---|---|---|---|---|---|---|---|
| 1 | min | 130 | 117 | 49 | 63.9 | 77.9 | 65.8 | 140 | 80.7 |
| 5 | min | 71 | 78.7 | 45.4 | 48.7 | 68.4 | 56.1 | 131 | 50.2 |
| 1 | hr | 15.7 | 21.1 | 21.5 | 18.2 | 19.5 | 23.3 | 34.8 | 16.4 |
| 24 | hr | 1.73 | 1.39 | 0.86 | 4.94 | 0.68 | 0.84 | 2.62 | 7.27 |

Table 2 has examples of NTU values for sample formulations tested for their ability to suppress dust generated from animal litter. NTU values that are lower than the control are indicative of reduced dust suppression as a lower level of suspended particles are visible in the aliquot when NTU is measure. A lower NTU value at a shorter time period is preferred as this is indicative of accelerated dust suppression compared to the control untreated animal litter. The animal litter tested contained wood chips. Data examples indicate in this series that KL-3 and KL-4 are the best in this data set for dust suppression. KL-5, KL-6 and KL-7 performed similarly to the control in this data set.

TABLE 2

| Time | control | KL-3 | KL-4 | KL-5 | KL-6 | KL-7 |
|---|---|---|---|---|---|---|
| 1 hr | 387 | 326 | 375 | 393 | 391 | 387 |
| 24 hr | 114 | 123 | 130 | 100 | 126 | 102 |

Table 3 has repeat examples of NTU values for sample formulations tested for their ability to suppress dust generated from animal litter. The animal litter tested did not contain wood chips. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series that KL-3 and KL-4, are still the best, followed by KL-6 in this data set for dust suppression. KL-5, and KL-7 performed similarly to the control in this data set.

TABLE 3

| Time | control | KL-3 | KL-4 | KL-5 | KL-6 | KL-7 |
|---|---|---|---|---|---|---|
| 1 hr | 648 | 532 | 468 | 680 | 522 | 622 |
| 24 hr | 212 | 161 | 134 | 196 | 145 | 165 |

Table 4 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. NTU measurements taken before decanting deionized water liquid phase and after decanting deionized water liquid phase. Data examples indicate in this series that all samples in this series performed better than the control for dust suppression. The best samples for dust suppression are PS65, and PS15, followed by A1, and PS33. These are then followed by PS-57, PS70, A2 and A3 in this data set.

TABLE 4

| Time | control | PS15 | PS33 | PS57 | PS65 | PS70 | A1 | A2 | A3 |
|---|---|---|---|---|---|---|---|---|---|
| Initial | 393 | 147 | 198 | 219 | 131 | 232 | 172 | 235 | 321 |
| 1 hr | 597 | 298 | 384 | 416 | 291 | 457 | 337 | 457 | 459 |
| Initial decant | 487 | 279 | 347 | 554 | 434 | 535 | 487 | 558 | 317 |
| 1 hr decant | 533 | 356 | 433 | 559 | 473 | 567 | 524 | 593 | 369 |

Table 5 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series further show that the dust suppression treatment is maintained on the surface of the animal litter and still has the ability to suppress fine particles over time. Both KL-3 and KL-4 maintain their dust suppression abilities.

TABLE 5

| | |
|---|---|
| 1 hr results | 24 hr results |

| | Fresh prep | 2 weeks | Fresh Prep | 2 weeks |
|---|---|---|---|---|
| Control | 648 | 637 | 212 | 158 |
| KL-3 | 532 | 479 | 161 | 154 |
| KL-4 | 468 | 414 | 134 | 173 |

Table 6 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series that all samples in this series performed better than the control for dust suppression. The best samples for dust suppression are KL-16 and KL-24 as they actually had definitive values at 5 min reading of the turbidity.

TABLE 6

| time | | control | KL-15 | KL-16 | KL-17 | KL-18 | KL-19 | KL-20 | KL-21 | KL-22 | KL-24 | KL-25 |
|---|---|---|---|---|---|---|---|---|---|---|---|---|
| 5 | min | OR | 0 | 19.82 | 0 | 0 | 0 | 0 | 0 | 0 | 21.73 | 0 |
| 1 | hr | 421 | 9.74 | 42.99 | 2.38 | 26.6 | 13.06 | 16.63 | 34.44 | 12.83 | 45.84 | 27.55 |
| 24 | hr | 132 | 3.79 | 21.97 | 4.55 | 0 | 21.21 | 0 | 9.85 | 1.52 | 24.24 | 21.97 |

Table 7 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series that all samples in this series performed better than the control for dust suppression. The samples for optimal dust suppression are KL-35 at 40% solids and KL-33 at 45% solids. Several of the candidates have excellent dust suppression after 5 mins in this data set.

TABLE 7

| | | Initial | 1 min | 5 min | 1 hr | 24 hr |
|---|---|---|---|---|---|---|
| | Control | | | | 528 | 82 |
| KL-27 | 10% | | | 1038 | 397 | 79.3 |
| | 50% | | | | 418 | 66.1 |
| KL-28 | 10% | | | 838 | 318 | 65.3 |
| | 53% | | | 752 | 392 | 49 |
| KL-29 | 10% | | | | 1018 | 110 |
| | 47% | | | | 792 | 95.9 |
| KL-30 | 10% | | | 789 | 380 | 58 |
| | 48% | | | | 595 | 108 |
| KL-31 | 10% | | | | 435 | 68.2 |
| | 40% | | | 1072 | 494 | 95.1 |
| KL-32 | 10% | | | 1013 | 488 | 84.5 |
| | 30% | | | | 789 | 95.2 |
| KL-33 | 10% | | | 872 | 350 | 68.1 |
| | 45% | | 1030 | 726 | 299 | 63.2 |
| KL-35 | 10% | | | 941 | 361 | 68.9 |
| | 40% | 819 | 678 | 492 | 212 | 62.1 |
| KL-37 | 10% | | | 825 | 338 | 67.5 |
| | 50% | | | 1037 | 369 | 63.1 |
| KL-38 | 10% | | | 895 | 381 | 63.4 |
| | 43% | | | 744 | 276 | 76.7 |
| KL-39 | 10% | | | 764 | 350 | 84.8 |
| | 50% | | | 866 | 369 | 64.4 |
| KL-40 | 50% | | | | 741 | 124 |

Table 8 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series that all samples in this series performed better than the control for dust suppression. The samples for optimal dust suppression are KL-44 at 10% and 40% solids. Several of the candidates have excellent dust suppression after 5 mins in this data set.

TABLE 8

| | | Initial | 1 min | 5 min | 1 hr | 24 hr |
|---|---|---|---|---|---|---|
| | Control | | | | 625 | 176 |
| KL-36 | 10% | | | | 424 | 167 |
| | 25% | | | 953 | 261 | 62.4 |
| KL-41 | 10% | | | | 335 | 156 |
| | 50% | | | 1008 | 290 | 86.2 |
| KL-43 | 10% | | | 775 | 286 | 71.8 |
| | 40% | | | 850 | 277 | 72.6 |
| KL-44 | 10% | | 966 | 640 | 230 | 77.6 |
| | 40% | | 1009 | 646 | 232 | 78.4 |
| KL-45 | 10% | | | 900 | 321 | 85.7 |
| | 34.41% | | | 736 | 249 | 94 |

Table 9 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series that all samples in this series performed better than the control for dust suppression. The samples for optimal dust suppression are KL-34 and KL-42 in this data set.

TABLE 9

| | | 1 hr | 24 hr |
|---|---|---|---|
| | Control | 812 | 120 |
| KL-34 | 10% | 367 | 55.9 |
| | 48% | 412 | 103 |
| KL-42 | 10% | 385 | 101 |
| | 37% | 462 | 125 |

Table 10 has examples of NTU values for sample formulations tested for their ability to suppress dust generated from animal litter. NTU values that are lower than the control are indicative of reduced dust suppression as a lower level of suspended particles are visible in the aliquot when NTU is measured. A lower NTU value at a shorter time period is preferred as this is indicative of accelerated dust suppression compared to the control untreated animal litter. Data examples indicate in this series that all samples in this series performed better than the control for dust suppression. The samples for optimal dust suppression are KL-46A and KL-46B in this data set.

TABLE 10

| | Initial | 1 min | 5 min | 1 hr | 24 hr |
|---|---|---|---|---|---|
| Control | OR | OR | OR | 465 | 86.6 |
| KL-46A | OR | OR | OR | 388 | 87.9 |
| KL-46B | OR | OR | OR | 483 | 124 |

OR = Over range

1. A method for reducing dust in particulate clay; said method comprising contacting clay particles with a polymer comprising at least 50 wt % polymerized units of acrylic acid and having M_{w} from 1,000 to 100,000.

2. The method of claim 1 in which the polymer is added to a dry composition comprising a particulate clay in an amount from 0.1 to 2 wt % of the clay.

3. The method of claim 2 in which the polymer comprises at least 60 wt % polymerized units of acrylic acid.

4. The method of claim 3 in which the particulate clay is a component of cat litter.

5. The method of claim 4 in which the polymer has M_{w} from 2,000 to 80,000.

6. The method of claim 5 in which the cat litter comprises bentonite.

7. The method of claim 6 in which the polymer comprises at least 80 wt % polymerized units of acrylic monomers.

8. The method of claim 6 in which the polymer has M_{w} from 2,500 to 40,000.

9. The method of claim 8 in which the polymer comprises at least 70 wt % polymerized units of acrylic acid.

10. The method of claim 9 in which the polymer has M_{w} from 3,000 to 30,000.
